(19) United States
(12) Patent Application Publication
(10) Pub. No.: US 2008/0022158 A1
(43) Pub. Date: Jan. 24, 2008

(54) DISPLAY SYSTEM AND METHOD FOR DISPLAYING SELF-TESTING MESSAGE

(75) Inventors: Yu-Cheng Tu, Taipei (TW); Hung-Hsiang Chou, Taipei (TW); Tsung-Yu Ma, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/762,721

(22) Filed: Jun. 13, 2007

(30) Foreign Application Priority Data
Jul. 20, 2006 (TW) 95126499

(51) Int. Cl. G06F 11/00

(52) U.S. Cl. 714/46; 714/E11.145

(57) ABSTRACT

A self-testing message displaying system suitable for a computer is provided. The computer has multiple hardware devices, and the basic input/output system performs a power on self-test sequence on the computer and outputs a self-testing code when one of the hardware devices is error. The self-testing message displaying system includes a mother board and a display device. The mother board having a memory is disposed in the computer, and the memory stores the device codes corresponding to the hardware devices. The display including an on screen display control device is electrically connected to the mother board and used to store the on screen display symbols corresponding to the codes of the hardware devices. The on screen display control device is capable of accessing the device codes corresponding to the self-testing codes from the memory, such that the display device displays the on screen display symbols corresponding to the device codes.

### CROSS-REFERENCE TO RELATED APPLICATION

This application claims the priority benefit of Taiwan application serial no. 95126499, filed on Jul. 20, 2006. All disclosure of the Taiwan application is incorporated herein by reference.

### BACKGROUND OF THE INVENTION

1. Field of the Invention

The present invention relates to a system and a method for displaying. More particularly, the present invention relates to a system and method for displaying a self-testing message when a computer is initialized.

2. Description of Related Art

Along with the development of semiconductor industry, the first large-scale general-purpose electronic computer has been changed to desktop computers, even for notebook computers with a smaller volume. The computer operates mainly by a chipset with the processing and computing functions and electronic devices driven by the chipset, wherein the chipset is disposed in the mother board of the computer. The mother board is configured in a chassis of the computer; therefore, once one of the electronic devices disposed on the mother board is damaged, causing the computer not to initialize or operated normally, a user has to disassemble the chassis and then test the electronic devices one by one. In order to resolve such problems, the conventional method is to make the mother board perform a power on self test (POST) after the computer has been initialized.

Generally speaking, the result of power on self test (POST) performed by the mother board can be displayed by various messages displaying methods. A conventional displaying method of the POST is to display the POST message of the mother board on the display screen of the computer, when the display card begins its operation. However, before the display card begins its operation, the user cannot determine whether other electronic devices can operate normally. Additionally, if the computer cannot be initialized normally because the display card cannot operate normally, the user cannot determine whether other electronic devices can operate normally. Furthermore, since the display frame of the test message is usually transient, it is quite difficult for the user to instantly record the test result.

A conventional method is to install a buzzer on the mother board, so as to remind the user of the POST message through buzzer sounds. However, the user must refer to the description of the user manual and then determine which electronic device causes the problem in initializing the computer according to the times of the buzzer sounds, which is quite inconvenient for the user.

Additionally, another conventional method is utilizing a 7-segment display installed on the mother board to display the POST message. However, this method has the same defects as the method of adopting a buzzer, and the user also has to refer to the user manual and then determines which electronic device causes the problem in initializing the computer.

Furthermore, another conventional method is mounting a light emitting diode on the mother board, and displaying the POST message according to the times of flicker of the light emitting diode. However, when employing this method, the user still has to refer to the user manual. Therefore, the above-mentioned methods of displaying the POST message are all inconvenient for the user.

### SUMMARY OF THE INVENTION

Accordingly, one objective of the present invention is to provide a system and method for displaying a self-testing message, such that a self-testing message can be displayed on the display without using the display card disposed on a mother board after a computer is initialized.

In order to achieve the aforementioned or another objective, the present invention provides a system for displaying a self-testing message which is suitable for a computer having a basic input/output system (BIOS). The computer comprises a plurality of hardware devices, and the BIOS perform a power on self-test sequence on the computer and output a corresponding self-testing code when one of the hardware devices is error. The system for displaying a self-testing message comprises a mother board and a display device. The mother board having a memory is disposed in the computer, and the memory stores the device codes corresponding to the hardware devices. The display device comprises an on screen display (OSD) control device, which is electrically connected to the mother board and used to store a plurality of OSD symbols corresponding to the device codes. The OSD control device is capable of accessing the device codes corresponding to the self-testing codes from the memory, such that the display device displays the OSD symbols corresponding to the device codes.

The present invention further provides a display device suitable for displaying a POST message of a computer having a BIOS. The computer comprises a plurality of hardware devices respectively corresponding to a self-testing code and a device code. The BIOS is used to perform a power on self-test sequence on the computer and outputs a corresponding self-testing code when one of the hardware devices is error. The display comprises an OSD control device which stores OSD symbols corresponding to the device codes, wherein the OSD control device is capable of accessing the device codes corresponding to the self-testing codes, such that the display device displays the OSD symbols corresponding to the device codes.

In one embodiment of the present invention, the OSD symbols are font-based or bit-map.

In one embodiment of the present invention, the hardware devices comprise at least one of a capacitor, a display card, a memory card, a sound card, a video card, a hard disk, a floppy disk driver, a CD-ROM driver, and a cache memory.

In one embodiment of the present invention, the memory is a BIOS memory.

In one embodiment of the present invention, the OSD control device comprises an OSD control unit.

In one embodiment of the present invention, the display device is an LCD, a flat panel display device, or a CRT (cathode ray tube) display device.

The present invention further provides a method for displaying a self-testing message, which is suitable for a computer having a BIOS, wherein the computer comprises a plurality of hardware devices respectively corresponding to a self-testing code and a device code. The displaying method comprises the following steps. First, the BIOS performs a power on self-test sequence on the computer. When one of the hardware devices is error, the BIOS outputs a corresponding self-testing code. Then, the device code corresponding to the self-testing code is accessed. Finally, the display displays an OSD symbol corresponding to the device code.

In one embodiment of the present invention, the displaying method further comprises a step of receiving a call instruction for a self-testing message and then displaying the self-testing message on the display device.

As for the system and method for displaying a self-testing message provided by the present invention, the memory disposed on the mother board and the OSD control device are utilized to enable the display to instantly display the self-testing message of the mother board. The system and method for displaying a self-testing message provided by the present invention provide convenience in use for users.

In order to the make aforementioned and other objects, features and advantages of the present invention comprehensible, a preferred embodiment accompanied with figures are described in detail below.

### BRIEF DESCRIPTION OF THE DRAWINGS

FIG. 1 is a schematic view of the system for displaying a self-testing message according to one embodiment of the present invention.

FIG. 2 is a flow chart of the method for displaying a self-testing message according to one embodiment of the present invention.

### DESCRIPTION OF EMBODIMENTS

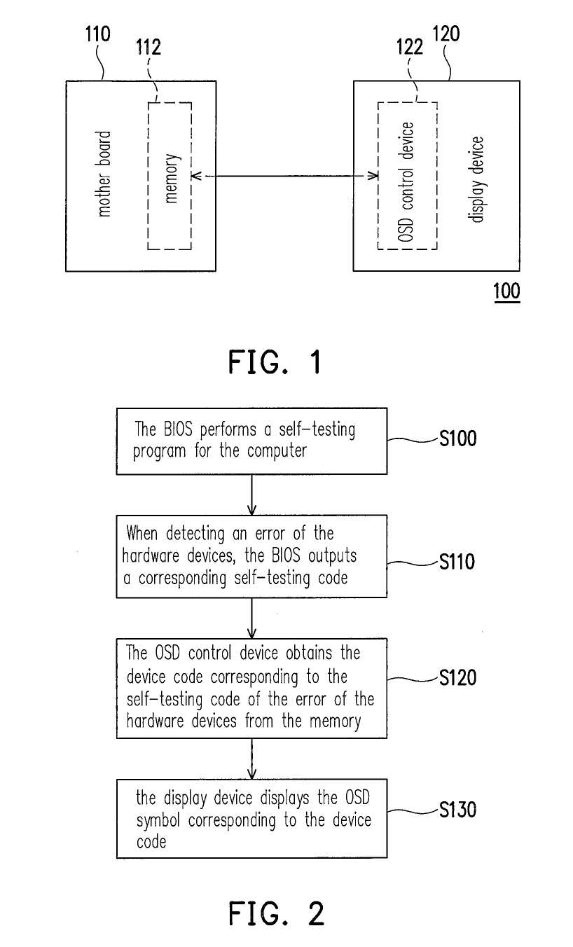

FIG. 1 is a schematic view of the system for displaying a self-testing message according to one embodiment of the present invention. Referring to FIG. 1, the system 100 for displaying a self-testing message described in the present embodiment is suitable for displaying a POST message of a computer having a BIOS, and the self-testing message is obtained through testing a plurality of hardware devices disposed in the computer by a mother board 110, wherein the hardware devices are, for example, a capacitor, a display card, a memory card, a sound card, a video card, a hard disk, a floppy disk driver, a CD-ROM driver, or a catch memory.

The system 100 for displaying a self-testing message includes a memory 112 and a display device 120. The memory 112 in the present embodiment is a BIOS memory. The memory 112 disposed on the mother board 110 stores a plurality of device codes corresponding to the plurality of hard devices and the BIOS, which is used to perform a power on self-test sequence on each of the hardware devices. Meanwhile, when any one of the hardware devices is error, the memory outputs a corresponding self-testing code. The display device 120 in the present embodiment is an LCD and includes an OSD control device 122, which stores a plurality of OSD symbols corresponding to the device codes respectively, wherein the OSD control device 122 is electrically connected to the memory 112 of the mother board 110. Additionally, the OSD control device 122 in the present embodiment is capable of accessing the device codes corresponding to the self-testing codes from the memory, such that the display device 120 displays the OSD symbols corresponding to the device codes.

In order to make the present embodiment become more fully understood and then be carried out, the method for displaying a self-testing message provided by the present invention will be illustrated below.

FIG. 2 is a flow chart of the method for displaying a self-testing message provided by the present invention. Referring to FIGS. 1 and 2, in Step S100, the BIOS performs a power on self-test sequence for the computer. More particularly, when the user turns on the power of the computer, i.e. the computer is initialized, the BIOS will automatically tests each of the hardware devices in the computer.

In Step S110, when an error of the hardware devices is detected, the BIOS outputs a corresponding self-testing code. In the present embodiment, the self-testing code is stored in the memory 112.

In Step S120, if one of the hardware devices initializes error, the OSD control device obtains the device code corresponding to the self-testing code from the memory. The OSD control device stores a plurality of OSD symbols corresponding to the device codes, and the OSD symbols may be font-based or bit-map.

In Step S130, the display device 120 displays the OSD symbol corresponding to the device code. More particularly, after the OSD control device 122 obtains the device code corresponding to the self-testing code from the memory 112, the display device 120 displays the OSD symbol corresponding to the device code. Additionally, the OSD control device 122 may receive a call instruction for a self-testing message, after that the OSD control device 122 displays the corresponding OSD symbol.

In the system and method for displaying a self-testing message of the present embodiment, after testing each of the hardware devices to obtain the self-testing code, the OSD control device 122 may obtain the device code corresponding to the self-testing code. The OSD symbol corresponding to the device code is displayed on the display device 120. Compared with the conventional technology, the user can instantly determine whether each of the hardware devices can operate normally before the display card begins its operation. Furthermore, even if the pre-booting or the booting program completes, the OSD symbol is still capable of displaying on the display device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for displaying a self-testing message, suitable for a computer having a basic input/output system (BIOS), wherein the computer has a plurality of hardware devices, and the BIOS performs a power on self-test sequence on the computer and outputs a corresponding self-testing code when one of the hardware devices is error, the system for displaying a self-testing message comprising:
a mother board disposed in the computer, the mother including a memory storing a plurality of device codes corresponding to the hardware devices; and
a display device including an on screen display (OSD) control device electrically connected to the mother board and used to store OSD symbols corresponding to the device codes, the OSD control device being capable of accessing the device codes corresponding to the self-testing codes from the memory, such that the display device displaying the OSD symbol corresponding to the device code.

2. The system for displaying a self-testing message as claimed in claim 1, wherein the OSD symbols are font-based or bit-map.

3. The system for displaying a self-testing message as claimed in claim 1, wherein the memory is a BIOS memory.

4. The system for displaying a self-testing message as claimed in claim 1, wherein the power on self-test sequence sequentially checks the hardware devices when the computer is initialized.

5. The system for displaying a self-testing message as claimed in claim 4, wherein the hardware devices comprise at least one of a capacitor, a display card, a memory card, a sound card, a video card, a hard disk, a floppy disk driver, a CD-ROM driver and a cache memory.

6. The system for displaying a self-testing message as claimed in claim 1, wherein the OSD control device comprises an OSD control unit.

7. The system for displaying a self-testing message as claimed in claim 1, wherein the display device is one selected from the group consisting of a liquid crystal display (LCD), a flat panel display, and a cathode ray tube (CRT) display.

8. A method for displaying a self-testing message, suitable for a computer having a BIOS, wherein the computer has a plurality of hardware devices each corresponding to a self-testing code and a device code, the method for displaying a self-testing message comprising:
performing a power on self-test sequence by the BIOS on the computer;
outputting a corresponding self-testing code by the BIOS when one of the hardware devices is error;
obtaining the device code corresponding to the self-testing code; and
displaying an OSD symbol corresponding to the device code on a display.

9. The method for displaying a self-testing message as claimed in claim 8, further comprising a step of receiving a call instruction for a self-testing message.

10. The method for displaying a self-testing message as claimed in claim 8, wherein the OSD symbols are font-based or bit-map.

11. The method for displaying a self-testing message as claimed in claim 8, wherein the power on self-test sequence sequentially checks the hardware devices when the computer is initialized.

12. A display device, suitable for displaying a power on self test (POST) message of a computer having a BIOS, wherein the computer includes a plurality of hardware devices respectively corresponding to a self-testing code and a device code, the BIOS is used to perform a power on self-test sequence for the computer and outputs a corresponding self-testing code when one of the hardware devices is error, the display device comprises an OSD control device used to store OSD symbols corresponding to the device codes, wherein the OSD control device is capable of accessing the device codes corresponding to the self-testing codes, such that the display device displays the OSD symbols corresponding to the device codes.

13. The display as claimed in claim 12, wherein the OSD symbols are font-based or bit-map.

14. The display as claimed in claim 12, wherein the display device is one selected from a group consisting of a liquid crystal display, a flat panel display, and a CRT display.
